(19) United States
(12) Patent Application Publication
(10) Pub. No.: US 2011/0315665 A1
(43) Pub. Date: Dec. 29, 2011

(54) BATTERY CASING MANUFACTURING METHOD

(75) Inventor: PEI-JAN HO, TAIPEI CITY (TW)

(73) Assignee: SIMPLO TECHNOLOGY CO., LTD., Hukou (TW)

(21) Appl. No.: 13/092,148

(22) Filed: Apr. 22, 2011

Related U.S. Application Data
(60) Provisional application No. 61/358,436, filed on Jun. 25, 2010.

(51) Int. Cl. B23K 26/00; B23K 31/02; B23K 20/10

(52) U.S. Cl. 219/121.64; 228/101; 228/110.1; 228/175; 228/170

(57) ABSTRACT

Disclosed is a battery casing manufacturing method which comprises: providing a casing film; providing a casing body; aligning the casing film and the casing body; and connecting the casing film and the casing body by using a welding process. The welding process transmits energy to the predetermined joint area of the casing film and/or the casing body in a non-physical contact way to make them connected.

### BACKGROUND OF THE INVENTION

1. Field of the Invention

The present invention relates to a battery manufacturing method, especially to a battery casing manufacturing method.

2. Description of Related Art

One of the prior arts for manufacturing battery casings is the method named in-mold film (IMF). IMF method comprises an insert mold step (a.k.a. injection step). FIG. 1 illustrates preparing a film for making a battery casing. FIG. 2 shows how to utilize a mold to execute the insert mold step of IMF method to fabricate a battery casing. Referring to FIGS. 1 and 2, IMF method comprises the following steps.

Step S02: Prepare an exterior casing film 111.

Step S04: As shown in FIG. 2, place the exterior casing film 111 in the mold cavity 123 defined by a mold 120. Generally, the mold 120 comprises an upper mold 121 and a lower mold 122 while one of them has an injection entrance. Take FIG. 2 for instance, the lower mold 122 has an injection entrance which connects to the mold cavity 123 defined by the upper and lower molds 121, 122. The mold cavity 123 must be shaped to fit the contours of the exterior casing film 111 and a casing body 112 which will be formed in the following step. Besides, the upper mold 121 carries static electricity to attract and position the exterior casing film 111.

Step S06: Inject melted plastic material into the mold cavity 123 through the injection entrance in an extrusion process.

Step S08: Cool the melted plastic material to solidify it to form the casing body 112 which then integrates with the exterior casing film 111.

Step S10: Separate the upper mold 121 and the lower mold 122 to obtain the battery casing 110.

The aforementioned IMF method, however, has at least the following disadvantages.

First, IMF method is complicated, which easily encumbers the production yield.

Second, the injection step is performed under high pressure and temperature while the exterior casing film 111 easily gets deformed due to the melted plastic material under such an environment.

Third, the battery casing appearance has stress marks which are physical phenomena and hardly overcome.

Fourth, the shape of the mold cavity 123 and the position of the injection entrance should take the contour of the exterior casing film 111 into account, which increases the difficulty of making the mold 120.

Fifth, since the entire exterior casing film 111 and the entire casing body 112 made of melted plastic material have to go through the heating and cooling processes, their different shrinkage rates based on their different shapes, volumes, materials, and etc., consequently cause the difficulty to control the degree of deformation of the battery casing 110.

### SUMMARY OF THE INVENTION

In view of the problems of IMF method, the present invention provides a battery casing manufacturing method to improve the battery casing production.

According to an embodiment of the present invention, a battery casing manufacturing method comprises the steps of providing a casing film, providing a casing body, aligning the casing film and the casing body, and utilizing a welding process to connect the casing film and body, wherein the welding process provides energy for a predetermined joint area of the casing film and body in a non-physical contact way to connect them. Please note that the size of the predetermined joint area is determined by the type of the adopted welding process and/or other production requirements. In this embodiment, the predetermined joint area uses a part, not all, of the corresponding area between the casing film and casing body.

In the present invention, the welding process could be, but not limited to, an ultrasonic joint process, a laser welding process and/or a thermal welding process. Besides, the step of aligning the casing film and the casing body is carried out in a non-electrostatic attraction way such as using glue or using corresponding positioning members formed on the casing film and body respectively.

In an embodiment of the present invention, the step of providing an casing film further comprises a printing step for forming a pattern on the casing film, a shaping step for shaping the casing film according to a predetermined three-dimensional shape, and a trimming step for trimming the superfluous part of the casing film to fit the contour of the casing body.

In another embodiment of the present invention, the step of providing the casing film comprises a printing step for forming a pattern on the casing film and a shaping step for forming the casing film with a predetermined three-dimensional shape. Furthermore, after finishing the welding process for connecting the casing film and the casing body, a trimming step is executed to trim the superfluous part of the casing film to suit the shape of the casing body.

In a further embodiment, the battery casing manufacturing method comprises the steps of providing an casing film, providing a casing body, aligning the casing film and casing body in a non-electrostatic attraction way, and combining the casing film with the casing body through a welding process which could be one or any combination of the existing connection methods including an ultrasonic joint technique, a laser welding technique and a thermal welding technique, wherein the welding process transmits energy to the predetermined joint area of the casing film and the casing body to have them connected.

Accordingly, in the present invention, the casing film and body are manufactured respectively and connected together through a connection process such as a welding process. Therefore, the mold for producing the casing body could be done in an easy and inexpensive way to reduce the production cost. Moreover, since the casing film and the casing body are produced independently, the deformation control is more easily achieved.

These and other objectives of the present invention will no doubt become obvious to those of ordinary skill in the art after reading the following detailed description of the preferred embodiment that is illustrated in the various figures and drawings.

### BRIEF DESCRIPTION OF THE DRAWINGS

FIG. 1 is a diagram illustrating the battery casing manufacturing method of the prior art.

FIG. 2 is a diagram illustrating the conventional IMF method.

FIG. 3A˜3D shows an embodiment of the battery casing manufacturing method of the present invention.

FIG. 4 is a cross-section diagram showing the structure of the battery casing along the line AA′ of FIG. 3D.

### DETAILED DESCRIPTION OF THE PREFERRED EMBODIMENTS

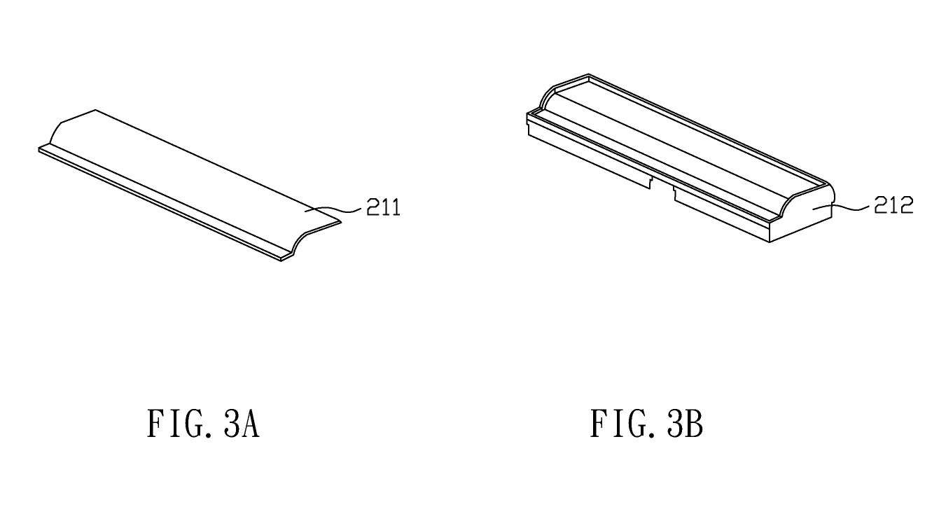

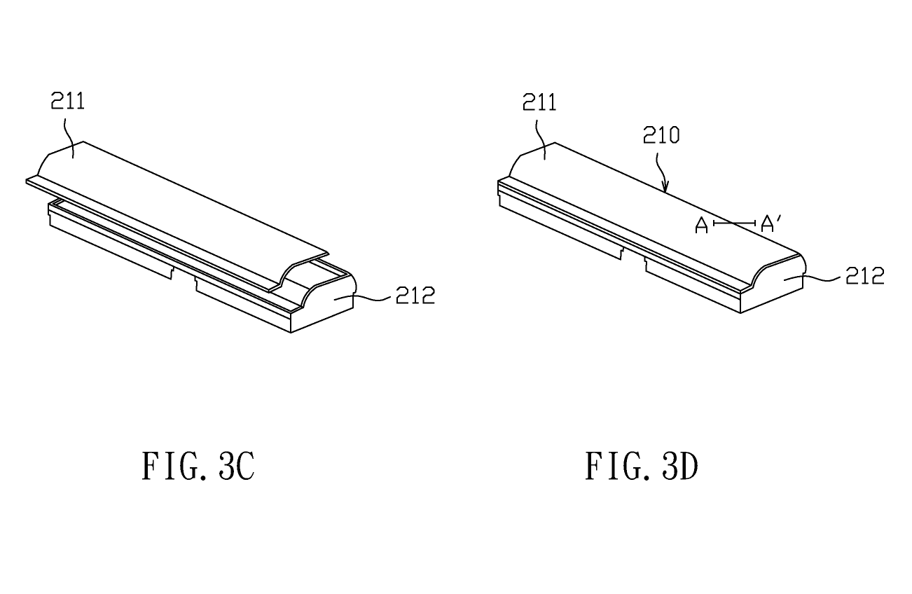

FIGS. 3A˜3D illustrate an embodiment of the battery casing manufacturing method of the present invention. Referring to these figures, the battery casing manufacturing method comprises the following steps.

Step S22: Provide a casing film 211 as shown in FIG. 3A.

Step S24: Provide a casing body 212 as shown in FIG. 3B. The casing body 212 can be formed by a conventional injection molding process instead of the insert mold step of IMF method, which thereby has its deformation under control and needs not to consider the potential deformation of the casing film 211. To be more specific, since the casing body 212 and the casing film 211 are formed respectively and then connected by a welding process in the following step, the restriction of preserving the injection entrance, the difficulty of positioning the casing film 211 by using the electrostatic technique, and the problem of controlling the different shrinkage rates between the casing film and body are eliminated. As a result, the mold for manufacturing the casing body 212 can be designed in a simple and inexpensive way to thereby save the production cost. Moreover, both the casing film and body should be discarded when the insert mold step of IMF method failed, while only the defective one is discarded in the present invention, which means that the present invention has a better production yield with lower cost.

Step S26: Align the casing film 211 with the casing body 212 as shown in FIG. 3C. In an embodiment, the casing film 211 is positioned on the casing body 212 in an adhesive and/or a mechanical way. The adhesive way could be realized by using glue. The mechanical way could be realized by setting a first positioning structure such as a concave on the casing body 212 and connecting it with a second positioning structure such as a convex set on the casing film 211. Please note that an artisan of ordinary skill in the art will appreciate how to use an existing method, not limited to the above-mentioned examples, to align the casing film 211 with the casing body 212.

In the conventional IMF method, an exterior casing film is positioned on the inner surface of an upper mold through electrostatic attraction. However, the electrostatic technique has the problem of attracting particles which decreases the product quality. Although this problem could be solved by installing the production line in a clean room, the production cost will thereby become another serious problem. Compared with the conventional IMF method, the step S26 of the present invention uses a non-electrostatic way to align the casing film 211 and the casing body 212 to avoid the above-mentioned problems.

Step S28: Use a welding process to combine the casing film 211 with the casing body 212 as shown in FIG. 3D. More specifically, the welding process transmits energy to a predetermined joint area of the casing film 211 and/or the casing body 212 in a non-physical contact way to have them connected. Please note that the size of the predetermined joint area is determined by the type of the adopted welding process, the design requirement, and/or the manufacture demand, and thereby can use a part or total area of the casing film 211/casing body 212 to fulfill the connection. In this embodiment, the step S28 further includes the following steps: step S82, which provides energy for the predetermined joint area of the casing film 211 and the casing body 212 respectively; and step S84, which cools the melted substances of the joint area of the casing film 211 and body 212 to thereby form a joint structure 213. Additionally, the step S84 may further includes the following steps: step S86 for having the melted substance of the casing film 211 blend with the melted substance of the casing body 212; and step S88 for having the melted substance of the casing body 212 mix with that of the casing film 211.

In other words, the step S28 transmits energy to the predetermined joint area of the casing film 211 and/or the casing body 212 to heat them and thereby has their melted substances blend with each other while the interstice between them will consequently be filled. After cooling the heated region, a joint structure 213 is obtained.

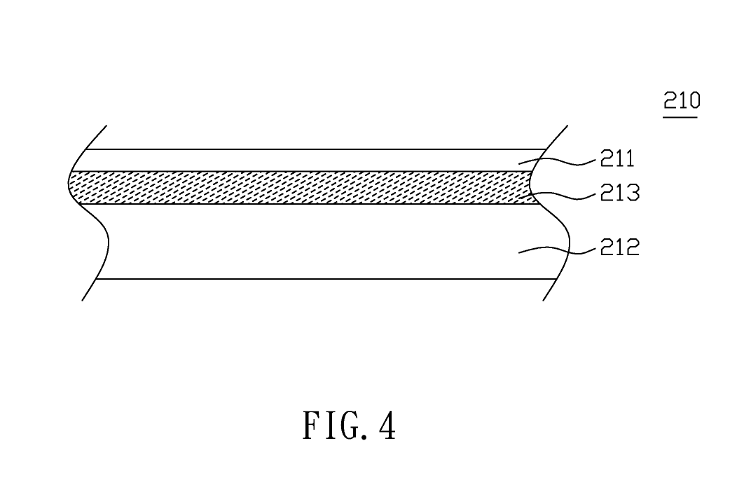

FIG. 4 is a cross-section diagram illustrating an exemplary structure of the battery casing 210 along the line AA′ of FIG. 3D. As shown in FIG. 4, the battery casing 210 comprises a casing film 211, a casing body 212 and a joint structure 213. The joint structure 213 is between the casing film 211 and body 212 for connecting them.

Please note that the welding process can be, but not limited to, one or any combination of an ultrasonic technique, a laser welding technique and a thermal welding technique (e.g. thermal glued technique). A person of ordinary skill in this art can appreciate how to utilize one or more existing connection methods to combine the casing film 211 with the casing body 212 in accordance with the disclosure of the present invention.

As to the thermal welding technique, it can be applied to one or both of the casing film 211 and body 212 to heat the predetermined joint area until the heated substances mixing with each other. The heating time and temperature and the size of the predetermined joint area are determined according to the type of the adopted welding process and/or the design and production requirements. Since the welding process and the design and production requirements are known in this filed, the unnecessary detail description is omitted here.

As to the laser welding technique, it can be applied to one or both of the casing film 211 and body 212 to heat the predetermined joint area until the heated substances mixing with each other. In a preferred embodiment, the predetermined joint area only uses a part, not total, of the casing film's surface/casing body's surface to save the production time and cost, while this is not a limitation to implementing the present invention. Besides, since the laser welding technique is well-known, the unnecessary detail description about this art is omitted here.

As to the ultrasonic joint technique, it utilizes the ultrasonic vibration to heat the predetermined joint area until the heated substances blending with each other. Similarly, since this technique is well-known in this filed, the unnecessary detail description is thereby omitted.

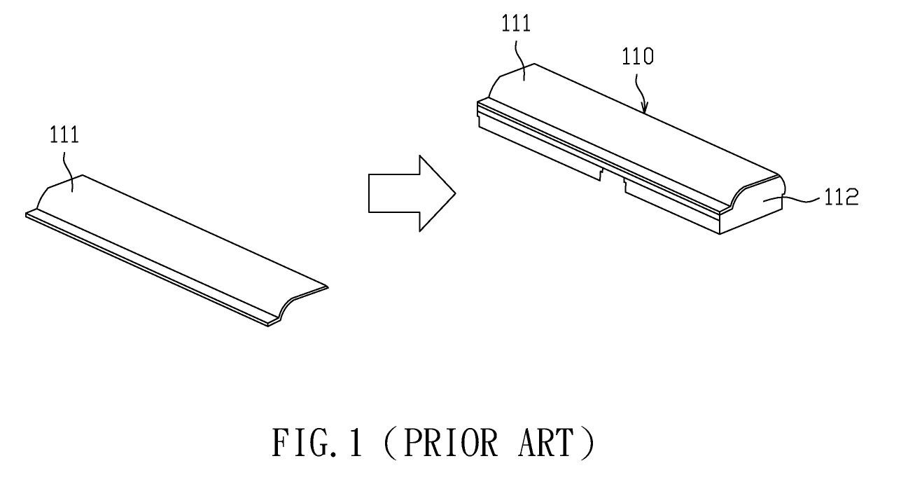

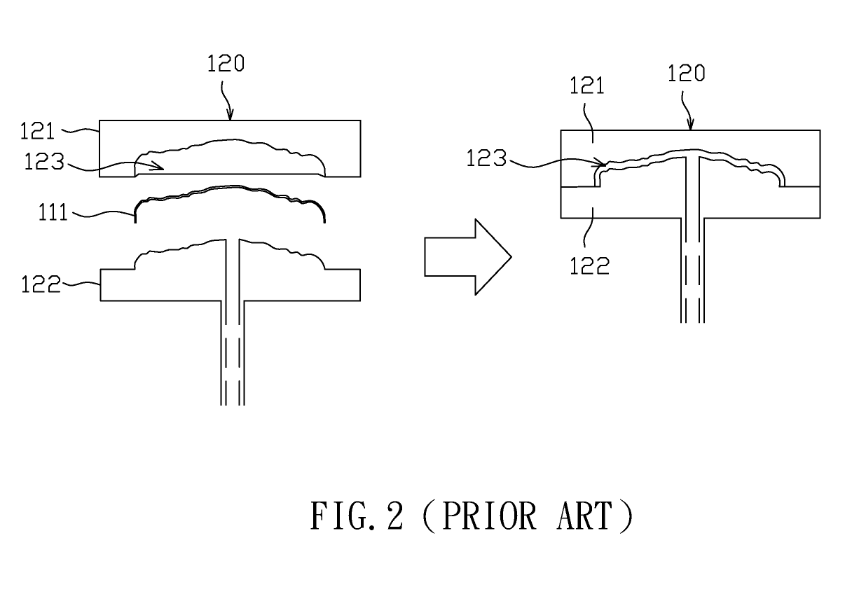

Referring to FIGS. 1 and 2 illustrating the conventional IMF method, the casing body 112 is made of melted plastic material and shrinks at the rate of about 0.4% when cooling, while the exterior casing film 111 with a thin thickness shrinks at the rate of about 0.8%. As a result, the battery casing 110 will easily get deformed because of the different shrinkage rates between the casing body 112 and film 111. Moreover, since the casing body 112 is made of melted material and shaped through cooling, the different parts of the casing body 112 with distinct thicknesses, contours, and/or sizes, which result in different cooling conditions, get different deformation and thereby the appearance of the battery casing 110 is affected.

Compared to the conventional IMF method, a preferred embodiment of the present invention only heats a part of the casing film 211 and/or the casing body 212 to carry out their connection, which won't affect the whole frame of the battery casing 210 and keeps its appearance under control. Take using laser welding technique and the casing film 211 with a thickness of about 0.3 mm for example, only a depth of 3˜5 μm is melted for connection while the rest part remains solid. Therefore, the shapes of the casing body 212 and film 211 stay unchanged as a whole; meanwhile, the battery casing 210 won't get out of shape. Please note that an artisan of ordinary skill in the art, after reading the disclosure of the present invention, will appreciate to what degree the depth and the area of the casing film 211 should be melted to carry out the union between the casing film 211 and body 212 on the basis of his desired design and production requirements.

In an embodiment, the step of forming the casing film 211 (i.e. step S22) comprises a printing step for forming a pattern on the casing film 211; a shaping step for shaping the casing film 211 in accordance with a predetermined three-dimensional shape; and a trimming step for trimming the superfluous part of the casing film 211 to fit the contour of the casing body 212. Please note that the shaping step is unnecessary when the three-dimensional shape is not demanded.

In another embodiment, the step of forming the casing film 211 (i.e. step S22) only comprises the printing step and the shaping step while the trimming step is performed after the casing film 211 combined with the casing body 212, which makes sure that the casing film 211 exactly fits the contour of the casing body 212. Referring to FIGS. 1 and 2, please note that the conventional IMF method can't perform a trimming step to its casing film 111 after the combination step because its casing film 111 needs trimming in advance to be placed into the mold 120 for realizing the insert mold step.

In a further embodiment of the present invention, the welding process is carried out by a plurality of laser welding apparatuses, which can accelerate finishing the welding process. The plurality of laser welding apparatuses can be used to process a plurality connection tasks respectively or to process a single task, i.e. connecting the casing film 211 with the casing body 212, to accelerate the production.

Finally, please note that the aforementioned descriptions represent merely the preferred embodiment of the present invention, without any intention to limit the scope of the present invention thereto. Various equivalent changes, alterations, or modifications based on the claims of present invention are all consequently viewed as being embraced by the scope of the present invention.

What is claimed is:

1. A battery casing manufacturing method, comprising:
providing a casing film;
providing a casing body;
aligning the casing film and the casing body; and
using a welding process to connect the casing film and the casing body, wherein the welding process transmits energy to a predetermined joint area of the casing film and/or the casing body in a non-physical contact way to connect the casing film and the casing body.

2. The battery casing manufacturing method of claim 1, wherein the predetermined joint area corresponds to a part area of the casing film and/or the casing body.

3. The battery casing manufacturing method of claim 1, wherein the welding process includes one or any combination of an ultrasonic technique, a laser welding technique and a thermal welding technique.

4. The battery casing manufacturing method of claim 1, wherein the casing film and the casing body are aligned in a non-electrostatic attraction way.

5. The battery casing manufacturing method of claim 4, wherein the casing film and the casing body are aligned through using glue or using corresponding positioning members formed on the casing film and the casing body respectively.

6. The battery casing manufacturing method of claim 1, wherein the step of providing the casing film comprises:
a printing step for forming a pattern on the casing film;
a shaping step for shaping the casing film according to a predetermined three-dimensional shape; and
a trimming step for trimming the superfluous part of the casing film in accordance with the contour of the casing body.

7. The battery casing manufacturing method of claim 1, further comprising:
executing a printing step for forming a pattern on the casing film;
executing a shaping step for shaping the casing film according to a predetermined three-dimensional shape; and
after finishing the step of connecting the casing film with the casing body, executing a trimming step for trimming the superfluous part of the casing film to make it fit the contour of the casing body.

8. The battery casing manufacturing method of claim 1, wherein the step of providing the casing film comprises:
a printing step for forming a pattern on the casing film; and
a trimming step for trimming the casing film in accordance with the contour of the casing body.

9. The battery casing manufacturing method of claim 1, further comprising:
executing a printing step for forming a pattern on the casing film; and
after finishing the step of connecting the casing film with the casing body, executing a trimming step for trimming the casing film to make it fit the contour of the casing body.

10. A battery casing manufacturing method, comprising:
providing a casing film;
providing a casing body;
aligning the casing film and the casing body in a non-electrostatic attraction way; and
using a welding process to connect the casing film and the casing body, wherein the welding process uses one or any combination of an ultrasonic technique, a laser welding technique and a thermal welding technique to transmit energy to a predetermined joint area of the casing film and/or the casing body to combine the casing film with the casing body.

11. The battery casing manufacturing method of claim 10, wherein the casing film and the casing body are aligned through using glue or using corresponding positioning members formed on the casing film and the casing body respectively.

12. The battery casing manufacturing method of claim 10, wherein the step of providing the casing film comprises:
a printing step for forming a pattern on the casing film;
a shaping step for shaping the casing film according to a predetermined three-dimensional shape; and
a trimming step for trimming the casing film in accordance with the contour of the casing body.

13. The battery casing manufacturing method of claim 10, further comprising:
executing a printing step for forming a pattern on the casing film;
executing a shaping step for shaping the casing film according to a predetermined three-dimensional shape; and
after finishing the step of connecting the casing film and the casing body, executing a trimming step for trimming the casing film to make it conform to the contour of the casing body.

14. The battery casing manufacturing method of claim 10, wherein the step of providing the casing film comprises:
a printing step for forming a pattern on the casing film; and
a trimming step for trimming the casing film in accordance with the contour of the casing body.

15. The battery casing manufacturing method of claim 10, further comprising:
executing a printing step for forming a pattern on the casing film; and
after finishing the step of connecting the casing film and the casing body, executing a trimming step for trimming the casing film to make it fit the contour of the casing body.
